(19) United States
(12) Patent Application Publication
(10) Pub. No.: US 2004/0225713 A1
(43) Pub. Date: Nov. 11, 2004

(54) SYSTEM AND METHOD FOR MULTI-WAY REMOTE AND LOCAL DEVICE CONTROL, ENABLING RECORDING AND REPLAY OF CONTROL COMMANDS AND DATA

(75) Inventors: Touraj Abbasi, Baku (AZ); Amir Niruyi, Westlake Village, CA (US); Derek Bacon, Westlake Village, CA (US); Dara Niruyi, Westlake Village, CA (US)

Correspondence Address: DALINA LAW GROUP, P.C., 7910 IVANHOE AVE. #325, LA JOLLA, CA, 92037, US

(73) Assignee: LINK2LINK CORP., Westlake Village, CA (US)

(21) Appl. No.: 10/249,775

(22) Filed: May 7, 2003

(51) Int. Cl. G06F 15/16

(52) U.S. Cl. 709/203

(57) ABSTRACT

This invention pertains to the field of local and remote play, recording and playback of end-unit control commands, and video, audio and text data, in standalone, local with or without network connection, one-to-one, one-to-many, or many-to-many sessions which can be recorded and replayed over networks in centrally located server architectures or peer-to-peer networks or a combination of both types of architectures simultaneously.

### BACKGROUND OF INVENTION

1. Field of the Invention

This invention pertains to the field of local and remote recording and playback of end-unit control commands, and video, audio and text data. More particularly, the invention relates to end-units that can be controlled in standalone, local with no network connection, local with network connection, one-to-one, one-to-many, or many-to-many sessions which can be recorded and replayed over digital communications networks using centrally located server architectures or peer-to-peer networks.

2. Description of the Related Art

Sensory interaction has always been an integral part of life. The physical sensation of touch and the sensations brought about by the other senses including sight, sound, taste and smell, have always been utilized for advantage when possible. Objects possessing desirable versions of these properties have long been sought after by living beings throughout the history of life. As species continue evolving with technology, the ability to enhance the level of sensory interaction will continue to increase.

Education continues to evolve. Children have interactive smart toys at earlier ages. These toys will continue to get more interactive, with sensory simulation, voice recognition, increased levels of touch, and perhaps smell and taste. Humans, dogs, dolphins and many other creatures respond to the external stimuli presented to the senses and for humans, there is an undeniable compelling need to view, hear, touch, taste and smell the world as we know it.

With the advent of modern communications, doctors can now see and operate on their patients remotely. Video conferencing has helped specialized medical practitioners visit patients that could not otherwise be attended. Video teleconferencing has also enabled a Whole new generation of people to see and hear and otherwise socialize without ever having to leave their home. Grandparents can now see their grandchildren from their home.

In this age of networked computers, the ability for living beings to readily communicate over vast distances is uncontroverted. Communication mediums include text messaging, audio, such as Voice over IP, video, and other devices allowing for tactile sensation feedback, 3-D imaging, and holographic technology.

Use of sight and sound interactively over computer networks brings living beings, especially humans together. As effective as audio and video is for communication, it is an incomplete set as true sensational interaction requires physical contact. A child”s favorite toy would be much more interactive if able to respond in real time with a grandmother's voice, albeit requiring a communications link and surrogate device manipulated by the remote grandmother's hand so she could feel and possibly watch the child play with the toy. Once people meet or communicate over a computer network, they are apt to seek further levels of interaction such as physical contact.

Previous inventions have not provided for a true means of interaction, and are unsuitable for local and remote recording and playback of device control commands and video, audio and text data. These inventions are incapable of recording and replaying a set of interactions associated with any off the shelf product containing controllable electrical, mechanical and thermal components in order to achieve this level of interaction whether locally or remotely displaced.

The invention described in U.S. Pat. No. 5,454,840 relates to an implanted device used for impotence correction that may be activated remotely, in the same physical location as the device, by the push of buttons. In this invention, the controlling device must be within the same locale and does not utilize a personal computer locally or remotely through the Internet, and does not allow groups of independent users to remotely control each others devices.

The invention described in U.S. Pat. No. 5,462,051 relates to a medical communication system which transmits physical information of a living body to a medical worker distantly located from the patient via telephone lines or by radio. For transmitting the instructions of the doctor to the patient and/or attendant person concurrently with the transmission of physical information of the patient to the doctor, another communication system is necessary which transmits the instructions of the doctor to the patient and/or attendant person via a communication channel different from that used for the transmission of the physical information of the patient to the doctor. The primary means of communication in the present invention is by way of the Internet or any other encrypted communications link. Further, the same communication medium is used to pass along two-way information in a continuous channel of information that is shared between two separate devices through a network of computers and servers, whether local or remote. Also, the medical communication system patent is silent on whether or not it allows the movements or actions of devices to be controlled locally or remotely utilizing a personal computer or otherwise.

The invention described in U.S. Pat. No. 5,467,773 relates to monitoring cardiac activity of a patient from a central location via a telephone connection while they remain at home. This two-way communication occurs over the public telephone switching network in order to monitor the cardiac patient. The invention fails to two-way communicate and record device commands through the use of personal computers by way of the Internet or any other encrypted communications link, and fails to communicate with a network of servers, and only communicates over the public telephone switching network which inhibits the rate of information transfer.

The invention described in U.S. Pat. No. 5,490,784 is a motion simulation device that allows the user to control the motion of the frame and the capsule, by a local suitable controller. The capsule can move and sensory input to the end users is achieved, however there is no way for a person in one of the capsules to control the motion of another's capsule, especially not in a remote location.

The invention described in U.S. Pat. No. 5,556,401 relates to a medical device used to manipulate the uterus during laparoscopic examination. The uterine device moves by manipulating a physical joystick which communicates with a processor via electrical wires or radio signals while the surgeon is in operating position. The device only receives commands-rather than allowing for two-way communication. Thus the described system lacks the principal features and advantages of bi-directional flow of sensory commands and their recording and playback with many-to-many groups of devices.

The invention described in U.S. Pat. No. 5,554,160 relates to a medical device used to manipulate the uterus during laparoscopic examination. The uterine device moves by manipulating a physical joystick which communicates with a processor via electrical wires or radio signals while the surgeon is in operating position. Thus the described system lacks the principal features and advantages of bi-directional flow of sensory commands.

The invention described in U.S. Pat. No. 5,544,649 relates to an ambulatory (in the home) patient health monitoring system wherein a health care worker at a central station monitors a patient, while the patient is at a remote location. The healthcare worker may monitor the medical condition of the patient by means of two-way audio and visual communications and one-way data transfer (from patient to central station). There is no mention of using any technology to control the movements of a device, locally or remotely, by means of a graphical user interface or otherwise. Also, the monitoring invention only allows for one-way data transfer rather than allowing for two-way data transfer and of course does not allow groups of remotely located devices to interact in a session.

The invention described in U.S. Pat. No. 6,368,268 relates to controlling remote sexual stimulation devices over the internet. The patent suffers many limitations in that it appears to be designed for only one-to-one sessions, does not have administration servers attached, cannot record live video, audio since it is only concerned with prerecorded playback, cannot utilize text based chat, does not compress live video and save it, appears to work only with sexual stimulating devices. In addition, the invention cannot work in local mode, and cannot playback locally recorded stimuli without a connection to the outside network and in general cannot be used to record device control commands at all, nor playback these commands or record video, audio or text data on the local or remote computing device, or central server.

### SUMMARY OF INVENTION

Embodiments of the present invention allow multiple loved ones to make virtual house calls, record them and play them back through robotics, or via electrical circuitry within a mechanical unit, such as with electromechanical, thermal and tactile devices embedded within a stuffed animal, or any combination therein. Examples of electromechanical devices include motors, actuators and the like. These types of devices, when enabled with communications allowing them to be controlled, recorded and played back are termed “end-units” in this disclosure and may include video, audio and text end-device command data inputs and outputs.

The end-unit control commands and video, audio and text data can be locally or remotely recorded so that the interaction can be replayed at a later time. These interactions could, for instance, allow a deceased relative to be remembered by replaying his or her last manipulations of a child's toy, including the sound of the relative's voice and words displayed in text, and video of the relative's face on an associated video panel as would be possible with a Teletubbies (Â®& Â©1996 Ragdoll Ltd.) doll enabled with aspects of the present invention. These types of interactions enable enhanced experiences in higher learning, entertainment, medical or artistic events and all other situations where remote interaction could be indirectly or directly applied.

An embodiment of the invention comprises a system and method that provides living beings with a mechanism for communicating via an enhanced level of sensory interaction. The system and method is configured to function across any communication interconnect and can, for example, use the Internet or other communications mediums such as cable, telephone, satellite or any other WAN, LAN or wireless communications network capable of transmitting data. Thus it is possible to implement many different embodiments of the invention, using any communication system, that comprises an electronic circuit board controlling and monitoring a device, communications library or driver, software control panel, communications mediums, reflection servers, administration servers, including billing servers, and/or other servers such as maintenance, customer service, marketing and any other server in the system used in support of the main functions of the system. The circuit board may reside within or be attached to a variety of different electronic devices which may include motors, actuators and other sensory stimulation and detection devices of varying size and capability. The circuit board may further be attached to a computer to facilitate communications, or communicate autonomously. The communications mediums used by embodiments of the invention include, but are not limited to, serial connections, USB, wireless, or any other communication medium where logical signals can be sent, including infrared and radio frequency. The circuit board communicates with a Communication Library or Driver, referred to from this point on as “driver”, receiving a variety of different commands locally or remotely and sending local commands out for local or remote interaction, possible recording and eventual playback in standalone, local without network connection, local with network connection, one-to-one, one-to-many and many-to-many sessions of video, audio, text data and end-unit control commands.

The next layer of technology communicating with the Driver is known as the Control Panel. The control panel comprises a program and a graphical user interface with elements that represent commands that are sent to the driver and in turn command the circuit boards in the end-units to send or receive video, audio, text or end-unit control commands. For simplicity, communication with the circuit board will signify communicating with the end-unit. The control panel and associated graphical user interface may be configured to run in a variety of web browsers or run as a standalone program or run as a component within a portal or run as an independent browser, or run as an applet residing in a virtual machine enabled cell phone, PDA or any other electronic device capable of remote communication. The end-unit and computing device may reside in the same physical entity. Each graphical user interface will contain customized interface elements depending upon the end-unit it is controlling and may include video, audio and text elements in addition to command, control and other options.

An embodiment of the invention controls actions from the circuit board in the end-unit via a communication medium that may use digital key signatures and encryption. The control panel can be utilized by the user to securely command such interactions to occur remotely within another geographical location throughout the world.

The control panel allows multiple entities to control one or more remote end-units through a communication medium such as the Internet. The end-unit may be a variety of devices including a children's toy, a favorite stuffed animal, an action hero, an adult toy, a higher learning mechanism, military device or any other remotely enabled device, with a corresponding graphical user interface control panel. This commanding display, such as the graphical user interface, is not the only place such commands can be identified by the user. The present invention allows for the unit itself to have the ability to send functions from a keypad, microphone, display or the like within the end-unit itself. The end-unit may be equipped with controls for controlling a local or remotely located end-unit, and toggle between any of the end-units for standalone, local without network connection, local with network connection, one-to-one, one-to-many or many-to-many configurations. The control panel can likewise control many other remotely located end-units.

An embodiment of the invention utilizes servers known as reflection servers and administrative servers which may include billing, marketing and other servers to monitor the usage of the end-units for targeted marketing purposes and other purposes including utilization resource planning, product development, such as server utilization planning with immediate command execution feedback.

The reflection servers are set up to communicate with the end-units using the IP address of a single user or plurality of users, including any proxy or firewall configuration information necessary to enable communication. The reflection servers and the administrative servers are also capable of monitoring the correct operation and general functioning of the end-units, including remote error debugging for customer support issues, and in addition to monitoring the time in which the end-units were used, how many times a user sent a certain function or command in addition to preference parameters that the user chose.

The driver, once it has received the command from the physical unit's display, keypad or microphone or by a customized graphical user interface within a computer screen, or via voice enabled technologies, or any combination of commanding via an electrical circuit board, will in turn communicate with the control panel in order to choose its path for pursuing the interaction to the remote geographical location.

The end-unit at the remote geographical location receives the command sent from the first circuit board, once it has been transferred over the breadth of the present invention's network system, known as reflective network system from this point on. The reflective network system comprises hardware such as reflection servers and administration servers. The network serves as the mediating communication port, hiding all complexities of communication from the end user. This port offers an open connection between the end-units located around the globe, and the reflection servers located internally. This open port connection offers end-unit owners and network users options on new software downloads or uploads. New end-unit capabilities can be downloaded (uploaded). New patterns and functions for commanding end-units via end-unit control command sequences or macros will be offered through the network and into the consumer end-unit. As the software evolves, the end-units can look to the network for new functionality and recent upgrades. Security of the connections may be maintained through SSL or other encryption technologies to the strength level allowed by law via encryption and digital signatures.

Upon connection of the end-unit, the network may authenticate each end-unit through use of a serial identification number in the end-unit or by a user password, after which the end-units may be initialized.

Upon acceptance of an active connection to the network system, the reflection server receives commands from a first end-unit or first control panel and sends them to the connection for the second control panel. This second control panel receives the data and sends it to the driver of the second end-unit and then forwards the command to the circuit board of the second end-unit. The remote connection through the reflection servers and into the second end-unit allows high levels of sensory interaction. Reflection servers can also store commands which may be played back later by the end user in order to relive a particularly good interaction, such as the final interaction between a loved one, or from an interaction recorded by a celebrity or expert in the field. The reflection servers may have continuous communication with the end-units once the end-units are authenticated through the Internet, although this is not necessary for an embodiment of the invention using a peer-to-peer topology, as the billing information can easily be saved on the peers and transmitted to the reflection server at any time.

An embodiment of the invention comprises receiving video information attached to the first computing device and then conveying the video in a compressed format to the second computing device. Some end-units can bypass a computing device and directly transmit video, audio, text data and end-unit control data as long as they are network enabled. Once the compressed video arrives at the second computing device, it is presented on a graphic display in a browser, in a portal area in a browser, in the control panel graphical user interface, or its own display device or any other device capable of displaying video. This provides a visual perception of the contact episode embodied in the manipulation of the mechanical surrogates, toys or other devices. Each endpoint can have video cameras and monitors. The video can be stored in compressed format on the reflection server or on each endpoint for peer-to-peer connections and eventual playback. The end-unit itself can comprise a video device.

An embodiment of the invention allows for transmission and receipt of audio information from a microphone attached to the first computing device. The audio is then conveyed to the second computing device where it is routed to a speaker system or audio output unit. This can be located anywhere, within the end-unit itself, or not. Both endpoints can utilize transmission and recording features, and save and replay audio along with video and command data as discussed in the previous paragraph. The end-unit itself can comprise a audio device.

An embodiment of the invention further allows for the capability of receiving text from a keyboard attached to the first computing device, conveying the text to the second computing device and then displaying the text on a graphic display on the second computing device. Voice recognition software can be utilized on each side of the connection for any user including hearing impaired users on the opposite side of the connection in order to display text corresponding to vocal interactions. Voice to text and text to voice software can be utilized for the return communication from any user including a hearing impaired person. Text can be saved and replayed later. The end-unit itself can also comprise a text device.

The monitoring facilities of the system may include authenticating serial numbers of every end-unit, additionally reading and reporting how each end-unit is used, which functions are used most often, how long the end-unit is being used for and the like. When remote end-units break, commands for bypassing broken features may be sent to the remote end-unit in order for it to recover from the error condition or reconfigure itself to bypass the error condition. The reporting information yields significant data on the use of the end-units and allows for targeted marketing, selling of marketing information, product development and quality control and information about recorded sessions.

In all situations where remote interaction is possible, local controls can be configured to override remote incoming commands. Billing for local control overrides can be at a different rate, and all billing can be done via the administration billing server or through a remote connection to an affiliates billing server.

Embodiments of the invention can be configured with devices for monitoring physiological end user data including but not limited to body temp, heart rate and brain activity. In addition, video encoding of corresponding motion whereby end-unit control commands can be sent in relation to actual displacements shown in video is enabled by the present invention.

### BRIEF DESCRIPTION OF DRAWINGS

FIG. 1 is a diagram of the architecture showing two end-units in a one-to-one configuration.

FIG. 2 is a diagram of the architecture showing six end-units in two sessions involving a one-to-one session and a many-to-many session.

FIG. 3 is a diagram of the architecture when utilizing a peer-to-peer paradigm, showing two independent sessions, a one-to-one session and a many-to-many session with four two-to-two links.

### DETAILED DESCRIPTION

An embodiment of the invention comprises a system and method that provides living beings with a mechanism for communicating via an enhanced level of sensory interaction. The system and method is configured to function across any communication interconnect and can, for example, use the Internet or other communications mediums such as cable, telephone, satellite or any other WAN, LAN or wireless communications network capable of transmitting data. Thus it is feasible to implement embodiments of the invention, using any communication system, that comprises an electronic circuit board controlling and monitoring a device, communications library or driver, software control panel, communications mediums, reflection servers, administration servers, including billing servers, and other servers such as maintenance, customer service, marketing and any other server in the system used in support of the main functions of the system. The circuit board may reside within or be attached to a variety of different input/output devices such as electronic devices which may include motors, actuators and other sensory stimulation and detection devices of varying size and capability. The circuit board may further be attached to a computer to facilitate communications, or communicate autonomously. The communications mediums used by embodiments of the invention include but are not limited to serial connections, USB, wireless, or any other communication medium where logical signals can be sent, including infrared and radio frequency. The circuit board communicates with a Communications Library or Driver, referred to from this point on simply as “driver”, receiving a variety of different commands locally or remotely and sending local commands out for local or remote interaction, possible recording and eventual playback in standalone, local without network connection, local with network connection, one-to-one, one-to-many and many-to-many sessions of video, audio, text data and device control commands.

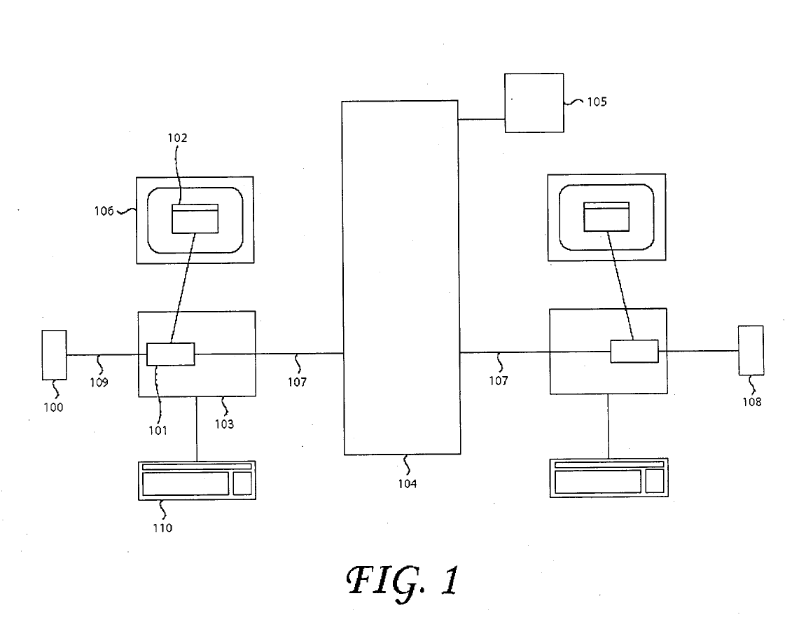

FIG. 1 shows an architectural view of the system. End-unit 100 communicates directly with computing device software component 101, comprising control panel non-graphical user interface code and communications driver. In this case for simplicity, the software is shown as grouped together and may or may not be compiled together as one unit depending upon the embodiment. Specifically, end-unit 100 communicates with driver contained in computing device software component 101. Note there can be a plurality of end-units 100 attached to computer 103. The driver in computing device software component 101 in turn communicates with control panel in the same software component 101 and displays information on control panel graphical user interface 102, from this point on known as control panel GUI.

When one end user initializes end-unit 100, the software component 101 opens control panel GUI 102 on the monitor 106 which is associated with computer 103. Alternatively, control panel GUI 102 can be started by the user independent of the operation of the end-unit 100 by pointing a browser, or starting up a standalone version of the program. Control panel GUI 102 causes a connection (e.g. IP) to be created to reflection server 104 via in software component 101. The reflection server looks up the target end user's IP address or addresses in the case of a multi-user session, or uses the input IP address if already known by the initiating user, and either initiates a connection, or connects the first user to an already open and waiting connection to the target end user end-unit 108. When the connections to both users are engaged, and if a billable session, the reflection server sends a command to the billing server 105 in order to record the start time for the interaction. As the communications line 107 from each control panel to the reflection server may be encrypted, no external sniffers or network debuggers can gain access to the ongoing communications when in this mode of communication. Keyboard 110 can be used in order to send text messages to end users. Upon a user exiting the session, the billing server is informed of the particular end-unit that is no longer in the session, causing the stop time of the session to be saved for billing for the corresponding user.

Operation of the system as a whole is not limited to one-to-one mappings, and may include sessions where one user controls sensory controllers for multiple end users on the other side of the reflection server. In addition to one-to-many mappings, many-to-many mappings may exist whereby a person can choose from a list of current users who may wish to experience interactions with.

When a end-unit is connected to the network system there is a continuous or intermittent flow of communication between the end-unit circuit board processor(s), software component 101, reflection server(s), administrative server(s), and in the case of a remote user, from the reflection server to that user's software component then to one or more end-unit(s) and their respective circuit board processor(s) to ensure proper end-unit status, command execution, determine whether a session is active, connections are proper and the like. In the case where the network system is integrated into a Web portal or site the continuous or intermittent communication flow, may include their associated network and administrative servers.

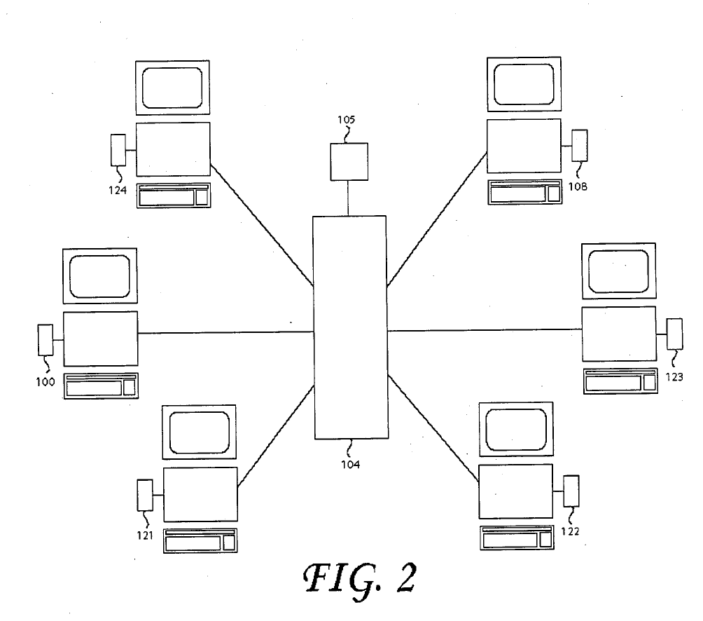

FIG. 2 shows two sessions whereby end users using end-units 100 and 124 are communicating one-to-one and end users using end-units 121, 122, 123 and 108 are experiencing sensory inputs from one or more of each of the other end users within that session. One end user using end-unit 121 could see video windows, hear sound, see chat text and control the sensory inputs of users selected from the remaining group in the session, namely end users associated with end-units 122, 123 and 108. Some users may wish to merely watch and listen to the interactions of others, which may be billed at a different rate, and still others may wish to not know who is controlling their associated end-unit. All combinations of these interactions are enabled by this system.

Reflection server 104 may be implemented with a highly scalable cluster of commercially available application servers for ease of maintenance, upgradeability, security, scalability, and ease of implementation issues. Reflection server 104 may contain a disk array or database in order to record incoming commands and data for future playback. This would include video, audio, and text data messages from keyboard 110 from the associated chat session and end-unit control commands from any of the end-units associated with the computing devices. Other tables in the database may contain information related to the types of end-units that each user has connected, metadata describing the avatar of the user including their picture, bio, drawings or other representations of themselves, computer type of the end user, operating system of the end user, device driver, circuit board firmware and circuit board version numbers, connection speeds for the connection to the end user, command patterns for the end-units, promotions, and any other data such as pain threshold or preference data associated with the end user.

Reflection server 104 may also contain updates to firmware for various end-units that are offered for download upon initial entry into the system, or upon user browsing after initialization. In addition, diagnostics and remote debugging can be performed via a customer service representative logged in directly or remotely to reflection server 104, or the customer service representative can directly access the computer and its associated end-units remotely via an IP address without traversing the reflection server.

On FIG. 1, operation of driver in software component 101 is as follows. Input commands from connection 109 interrupt the CPU of computer 103 in order to service the line. The input command makes a callback to the control panel program portion of software component 101 in order to inform it of the newly arrived command. The control panel updates its associated graphical user interface 102 and transmits the command to the driver and then to the reflection server 104. Any commands directed into the computer via communications line 107 are sent to the control panel program then to the driver, both contained in software component 101, and then forwarded to the circuit board in end-unit 100 via communications line 109. Commands sent through software component 101 may include identification queries, order query to access the sequence of commands received, state queries for the status of all end-units, state queries for the battery level of end-units such as 100 and 108, queries of error status, and command blocks containing command data for the associated end-units.

Operation of the control panel is as follows. Any chat typing or end-unit command data on keyboard 110 enters the control panel program and is sent out via the software component 101 through communications line 107 to reflection server 104 and all the way to the end-device 108. Any video camera signal or microphone signal is similarly sent over communications line 107 through the reflection server and onto computing device associated with the end-unit 108, and to end-unit 108 itself. Due to the possible private nature of the video, audio, chat and other sensory data, the communications link may be encrypted. The respective end-unit control commands are also sent over communications line 107 and are stored on reflection server 104 for later playback on either end-unit 100 or 108. In this manner, both sides of the interaction can be reflected, and in effect, the video, audio, command data and text can be replayed and experienced on other side of the reflection server. Control panel GUI 102 may be configured to display the various speeds or other sensory configuration parameters for the local and remote end-units per each connected end user, and may also include at least one video window per end user connected to the system. In addition, other parameters such as billing rate and total charges for session may be displayed; these rates may depend on the affiliate leasing the service.

Another embodiment of the invention uses a Peer to Peer (P2P) architecture in order to lookup other users, and find recorded sessions that are saved on end user machines. In the P2P architecture, the meeting place for end users is the reflection server or any third party portal servers, such as an online dating portal, which allows the users to find each other, and may notify the administration servers of the beginning or entering of a session or may notify the administration servers as soon as they are available on the network. The end users can have a heartbeat notifying the reflection server that they are still in the session, and if they exit the session, the control panel program can notify the reflection server directly. Once the users have found each other and a session has been initiated, they can autonomously communicate with or without need for the reflection server to maintain the recordings or playbacks, this limits the loads on the reflection server and allows users to take advantage of possibly very high speed connections within their immediate city or locale. By sending heartbeats, the end users may be billed only for the time that they are in the session, and if network errors or outages occur, they are only billed for the time that they are in the session. Upon normal termination of the session, the control programs on the various machines may send in exit commands to the reflection server with parameters recorded during the session, including the main compressed audio, video, text, and other commands, or this information can remain on the remote peer machines. Video, audio, text data and end-unit control commands can be simultaneously received from the reflection server, other remote computing device or local computer, or all of the different sources at the same time enabling replaying recorded data, and live data from the same or different sources simultaneously.

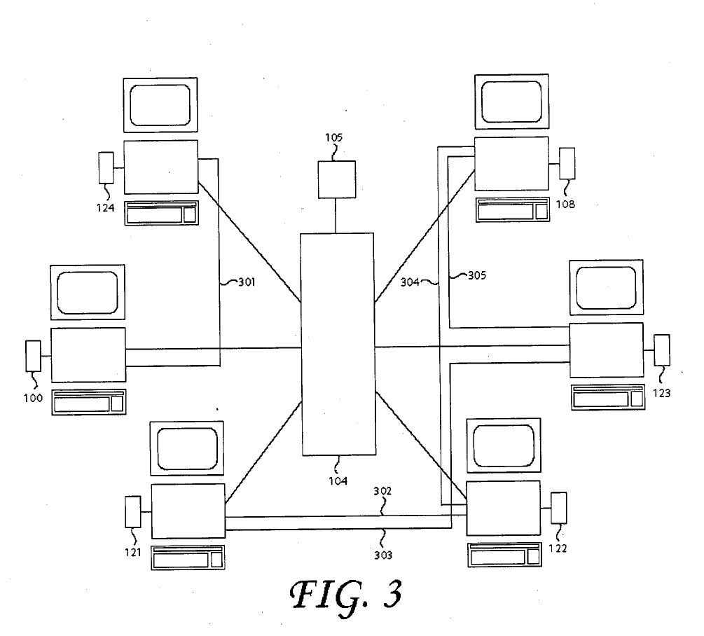

FIG. 3 shows the peer-to-peer topology. After entering a session, the control panel on computer associated with end-unit 100, or end-unit 100 itself, are both able to control end-unit 124 and both associated computers in this session are able to display video, play audio and text chat and send end-unit control commands to each other over direct connection 301, or obtain video, audio, text data or end-unit control commands from reflection server 104 simultaneously. The video, audio, text and end-unit control commands can comprise replaying or live or both simultaneously.

On the right side of FIG. 3, in a completely separate session, end-unit 121 is able to control end-units 122 and 123, and share audio, video and text data and end-unit control commands with the computers associated with these devices over direct connections 302 and 303 or the reflection server, again the video, audio and chat and end-unit control commands may be replayed or live. In addition, the reflection server 104 is still accessible and can be used as a source for replayed or live information or as a destination for real time recording of information from the session. Likewise, end-unit 122 can control end-units 121 and 108 over communication links 302 and 304 that may be encrypted, end-unit 123 can control end-units 121 and 108 over communication links 303 and 305, and end-unit 108 can control end-units 122 and 123, over connections 304 and 305 respectively. Again, these end-units can still access the reflection server for replay video or accessing live video, audio and chat, or store live video, audio or text data or end-unit control commands from the session.

Some of the communications links can be set up for partial unidirectional travel so that a user associated with end-unit 121 cannot see, or optionally hear, or optionally chat with computers associated with other end-units.

In addition, even though the computers are shown with one attached end-unit for simplicity, the amount of end-units hooked to each computer is limited only by the connection technology involved, e.g., for USB there could be over 100 devices connected to a single computer. In addition, the figures do not show speakers, or video cameras for simplicity, but as someone skilled in the art would recognize, these are easily linked to a computer with off the shelf components that are cheap, high quality and readily available at an electronics store. Embodiments of the invention may utilize any manufacturer's video, audio or keyboard devices.

What is claimed is:

1. A system comprising:
at least one end-unit;
at least one computing device wherein said at least one computing device allows control and data to be played and recorded;
a reflection server coupled with said at least one computing device over a communication interconnect wherein said reflection server allows control and data to be played and recorded;
an administration server coupled with said reflection server;
a device driver running on said at least one computing device communicating with said at least one end-unit; and,
a control panel software component running on said at least one computing device coupled to said device driver.

2. The system of claim 1 wherein said control panel software component communicates with said reflection server.

3. The system of claim 1 wherein said control panel software component communicates with a second control panel software component on a second computing device.

4. The system of claim 1 wherein said control panel software component communicates with a second control panel software component on a second computing device and with said reflection server.

5. The system of claim 1 wherein said at least one end-unit communicates with a second at least one end-unit over a reflective network system.

6. The system of claim 1, further comprising:
a video camera;
a microphone;
at least one speaker;
a keyboard;
said video camera, said microphone, said keyboard and said at least one speaker being coupled to said computing device.

7. The system of claim 1, wherein said at least one end-unit comprises an electromechanical device.

8. The system of claim 1, wherein said at least one end-unit comprises a motor.

9. The system of claim 1, wherein said at least one end-unit comprises a input/output device.

10. The system of claim 1, wherein said electromechanical device derives its power from said computing device.

11. The system of claim 1, wherein said electromechanical device derives its power from self contained batteries.

12. The system of claim 1, wherein said at least one end-unit comprises a controllable thermal device.

13. The system of claim 1, wherein said at least one end-unit comprises a tactile device.

14. The system of claim 1, wherein said at least one end-unit comprises at least one control input.

15. The system of claim 14, wherein said at least one control input comprises at least one toggle control function for toggling communication flow between at least one second end-unit.

16. The system of claim 1, wherein said at least one end-unit comprises an identification number.

17. The system of claim 1, wherein said reflection server comprises firmware updates.

18. The system of claim 1, further comprising a network configuration selected from the group consisting of standalone, local with no network connection, local with network connection, one-to-one, one-to-many, many-to-many.

19. A method of multi-way remote and local control, recording and replay of control commands and data comprising:
chatting with text;
watching live video;
listening to live sound;
controlling said at least one end-unit;
recording video, audio and text data, and end-unit control commands; and,
playing back recorded video, audio and text data, and end-unit control commands.

20. The method of claim 19 further comprising the steps of:
coupling an end-unit to a computing device;
starting a control panel software component;
selecting at least one end user to interact with in a session;
initiating a billing cycle for the session; and,
terminating said session; and,
logging said billing cycle.
